(19) United States
(12) Patent Application Publication
(10) Pub. No.: US 2026/0259621 A1
(43) Pub. Date: Sep. 3, 2026

(54) DISPLAY SUBSTRATE AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN); Beijing BOE Technology Development Co., Ltd., Beijing (CN)

(72) Inventors: Wenjie HOU, Beijing (CN); Qiujie SU, Beijing (CN); Yingmeng MIAO, Beijing (CN); Dongchuan CHEN, Beijing (CN); Xiaofeng YIN, Beijing (CN)

(21) Appl. No.: 18/995,762

(22) PCT Filed: May 14, 2024
(86) PCT No.: PCT/CN2024/093067

§ 371 Date: Jan. 16, 2025

(30) Foreign Application Priority Data
Jun. 9, 2023 (CN) 202310684865.3

(51) Int. Cl. G06F 3/041; G02F 1/1333; G02F 1/1343; G09G 3/36

(52) U.S. Cl. CPC G06F 3/04164; G02F 1/13338; G02F 1/134345; G09G 3/3677; G09G 2300/0408

(57) ABSTRACT

A display substrate and a display device are provided. The display substrate includes a base substrate, and a plurality of touch electrode blocks, a plurality of dummy subpixels and a common signal bus arranged on the base substrate. An orthogonal projection of the dummy subpixel onto the base substrate is located between an orthogonal projection of the common signal bus onto the base substrate and an orthogonal projection of the touch electrode block onto the base substrate, the dummy subpixel includes a dummy common electrode pattern, and the dummy common electrode pattern is coupled to the common signal bus.

### CROSS-REFERENCE TO RELATED APPLICATIONS

This application is the U.S. national phase of PCT Application No. PCT/CN2024/093067 filed on May 14, 2024, which claims a priority of the Chinese patent application No. 202310684865.3 filed on Jun. 9, 2023, the entire contents each of which are incorporated herein by reference in their entirety for all purposes.

### TECHNICAL FIELD

The present disclosure relates to the field of display technology, in particular to a display substrate and a display device.

### BACKGROUND

Recently, an In-Cell Touch product has attracted extensive attraction due to such advantages as being light and thin, and high definition. However, for a large-sized In-Cell Touch product, there is a relatively large difference among loads of touch electrode blocks, so its touch performance is greatly affected. Hence, there is an urgent need to improve touch uniformity.

### SUMMARY

An object of the present disclosure is to provide a display substrate and a display device.

In order to achieve the above object, the present disclosure provides the following technical solutions.

In one aspect, the present disclosure provides a display substrate, including a base substrate, and a plurality of touch electrode blocks, a plurality of dummy subpixels and a common signal bus arranged on the base substrate. An orthogonal projection of the dummy subpixel onto the base substrate is located between an orthogonal projection of the common signal bus onto the base substrate and an orthogonal projection of the touch electrode block onto the base substrate, the dummy subpixel includes a dummy common electrode pattern, and the dummy common electrode pattern is coupled to the common signal bus.

In a possible embodiment of the present disclosure, the common signal bus includes a bus body and a plurality of bus extension members coupled to the bus body, and the bus extension member is coupled to the dummy common electrode pattern in a corresponding dummy subpixel.

In a possible embodiment of the present disclosure, the bus body and the bus extension members form an integral piece, and the bus extension member is directly lapped onto the dummy common electrode pattern in the corresponding dummy subpixel.

In a possible embodiment of the present disclosure, the dummy subpixel further includes a dummy common electrode line, and the dummy common electrode line is coupled to an end of the dummy common electrode pattern; the dummy common electrode pattern extends in a first direction; and a first end of the dummy common electrode line and a first end of the bus extension member are arranged in the first direction, the first end of the dummy common electrode line is an end of the dummy common electrode line proximate to the bus body, and the first end of the bus extension member is an end of the bus extension member distal to the bus body.

In a possible embodiment of the present disclosure, a distance between the first end of the dummy common electrode line and the first end of the bus extension member is greater than or equal to one third of a length of the dummy common electrode pattern in the first direction.

In a possible embodiment of the present disclosure, the bus body is coupled to the bus extension member through a first conductive connection member, the dummy subpixel further includes a dummy common electrode line, the dummy common electrode line is coupled to an end of the dummy common electrode pattern, and the bus extension member is coupled to the dummy common electrode line in the corresponding dummy subpixel.

In a possible embodiment of the present disclosure, the bus extension member includes a first extension portion and a second extension portion coupled to each other, an extension direction of the first extension portion is the same as an extension direction of the bus body proximate to the first extension portion, and an orthogonal projection of the first extension portion onto the base substrate and an orthogonal projection of the bus body onto the base substrate are arranged in a direction intersecting the extension direction of the bus body proximate to the first extension portion; the second extension portion is coupled to the dummy common electrode line in the corresponding dummy subpixel; and the first conductive connection member is coupled to the bus body and the first extension portion.

In a possible embodiment of the present disclosure, a width of the first extension portion in a direction perpendicular to the extension direction of the first extension portion is greater than a width of the second extension portion in a direction perpendicular to an extension direction of the second extension portion.

In a possible embodiment of the present disclosure, an extension direction of the second extension portion is the same as an extension direction of the dummy common electrode line; or the extension direction of the second extension portion is the same as an extension direction of the dummy common electrode pattern; or the second extension portion includes at least two sub-portions coupled sequentially, and extension directions of two sub-portions proximate to each other are different.

In a possible embodiment of the present disclosure, the display substrate further includes a gate metal layer and a source/drain metal layer, the bus body is arranged at a same layer, and made of a same material, as the source/drain metal layer, and the bus extension member is arranged at a same layer, and made of a same material, as the gate metal layer.

In a possible embodiment of the present disclosure, the display substrate further includes a gate metal layer, and the bus body and the bus extension member are arranged at a same layer, and made of a same material, as the gate metal layer.

In a possible embodiment of the present disclosure, in a case that the bus extension member includes a first extension portion and a second extension portion coupled to each other, the bus body includes first bus portions and second bus portions arranged alternately, a width of the first bus portion is smaller than a width of the second bus portion in a direction perpendicular to an extension direction of the bus body, and the first bus portion and the first extension portion are arranged in the direction perpendicular to the extension direction of the bus body.

In a possible embodiment of the present disclosure, the display substrate further includes: a gate driving circuit and a plurality of scanning lines, at least a part of an orthogonal projection of the bus body onto the base substrate being located between an orthogonal projection of the gate driving circuit onto the base substrate and orthogonal projections of the plurality of scanning lines onto the base substrate; a plurality of second conductive connection members, an orthogonal projection of each of the second conductive connection members onto the base substrate partially overlapping with the orthogonal projection of the bus body onto the base substrate, the plurality of second connection members being coupled to the gate driving circuit; and a plurality of third conductive connection members and a plurality of fourth conductive connection members, each of the third conductive connection members being coupled to a corresponding second conductive connection member and a corresponding fourth conductive connection member, each of the fourth conductive connection members and a corresponding scanning line forming an integral piece.

In a possible embodiment of the present disclosure, the fourth conductive connection member includes a first conductive portion and a second conductive portion coupled to each other, an extension direction of the first conductive connection portion is the same as an extension direction of the bus body proximate to the first conductive portion, an orthogonal projection of the first conductive portion onto the base substrate and an orthogonal projection of the second conductive connection member onto the base substrate are arranged in a direction intersecting the extension direction of the bus body proximate to the first conductive portion, and an extension direction of the second conductive portion is the same as an extension direction of the scanning line; and the third conductive connection member is coupled to a corresponding second conductive connection member and the first conductive portion, and the second conductive portion and a corresponding scanning line form an integral piece.

In a possible embodiment of the present disclosure, at least a part of the orthogonal projection of the first conductive portion onto the base substrate is located between an orthogonal projection of the first extension portion onto the base substrate and an orthogonal projection of the dummy common electrode pattern onto the base substrate; the orthogonal projection of the first conductive portion onto the base substrate and at least a part of an orthogonal projection of the second extension portion onto the base substrate are arranged in the extension direction of the bus body proximate to the first conductive portion; and at least a part of the orthogonal projection of the first conductive portion onto the base substrate and at least a part of the orthogonal projection of the second extension portion onto the base substrate are arranged in a direction intersecting the extension direction of the bus body proximate to the first conductive portion.

In a possible embodiment of the present disclosure, the display substrate further includes: a gate driving circuit and a plurality of scanning lines, at least a part of an orthogonal projection of the bus body onto the base substrate being located between an orthogonal projection of the gate driving circuit onto the base substrate and orthogonal projections of the plurality of scanning lines onto the base substrate; and a plurality of second conductive connection members, an orthogonal projection of each of the second conductive connection members onto the base substrate partially overlapping with an orthogonal projection of the bus body onto the base substrate, the plurality of second conductive connection members being coupled to the gate driving circuit, and the second conductive connection member and a corresponding scanning line forming an integral piece.

In a possible embodiment of the present disclosure, the display substrate further includes a plurality of normal subpixels, and each of the normal subpixels includes a normal common electrode pattern; a plurality of normal common electrode patterns included in the plurality of normal subpixels is grouped into the plurality of touch electrode blocks, each of the touch electrode blocks includes at least two normal common electrode patterns, and in a same touch electrode block, the normal common electrode patterns arranged in a second direction are coupled to each other through a normal common electrode line; and the dummy subpixel further includes a dummy common electrode line, and a gap is provided between the dummy common electrode line and the normal common electrode line proximate to the dummy common electrode line in the second direction.

In a possible embodiment of the present disclosure, the display substrate further includes a plurality of data lines, and an orthogonal projection of each of the data lines onto the base substrate partially overlaps with an orthogonal projection of the normal common electrode line onto the base substrate.

In a possible embodiment of the present disclosure, the dummy subpixel further includes a dummy common electrode line, an end of the dummy common electrode pattern coupled to the dummy common electrode line includes a first notch, and the first notch is arranged proximate to the normal common electrode line.

In a possible embodiment of the present disclosure, the end of the dummy common electrode pattern coupled to the dummy common electrode line further includes a second notch, and the second notch is arranged opposite to the first notch in the second direction.

In another aspect, the present disclosure provides in some embodiments a display device including the above-mentioned display substrate.

### BRIEF DESCRIPTION OF THE DRAWINGS

The following drawings are provided to facilitate the understanding of the present disclosure, and constitute a portion of the description. These drawings and the following embodiments are for illustrative purposes only, but shall not be construed as limiting the present disclosure. In these drawings,

FIG. 1 is a schematic view showing layout of a display substrate according to one embodiment of the present disclosure;

FIG. 2 is a schematic view showing the layout of a gate metal layer and a first conductive layer in FIG. 1;

FIG. 3 is a schematic view showing the layout of a source/drain metal layer added on the basis of FIG. 2;

FIG. 4 is another schematic view showing the layout of the display substrate according to one embodiment of the present disclosure;

FIG. 5 is a schematic view showing the layout of the gate metal layer and the first conductive layer in FIG. 4;

FIG. 6 is a schematic view showing the layout of the source/drain metal layer added on the basis of FIG. 5;

FIG. 7 is yet another schematic view showing the layout of the display substrate according to one embodiment of the present disclosure;

FIG. 8 is a schematic view showing the layout of the gate metal layer and the first conductive layer in FIG. 7;

FIG. 9 is a schematic view showing the layout of the source/drain metal layer added on the basis of FIG. 8;

FIG. 10 is still yet another schematic view showing the layout of the display substrate according to one embodiment of the present disclosure;

FIG. 11 is a sectional view of the display substrate along line A1-A2 in FIG. 10;

FIG. 12 is a schematic view showing the layout of the gate metal layer and the first conductive layer in FIG. 10;

FIG. 13 is a schematic view showing the layout of the source/drain metal layer added on the basis of FIG. 12; and

FIG. 14 is a schematic view showing the display substate according to one embodiment of the present disclosure.

### DETAILED DESCRIPTION OF THE EMBODIMENTS

The following description will be given in details in conjunction with the drawings and embodiments.

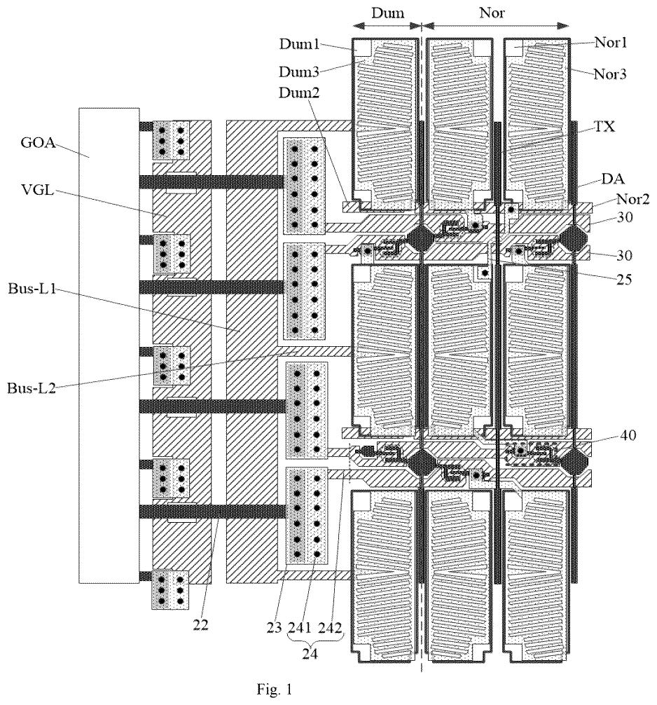

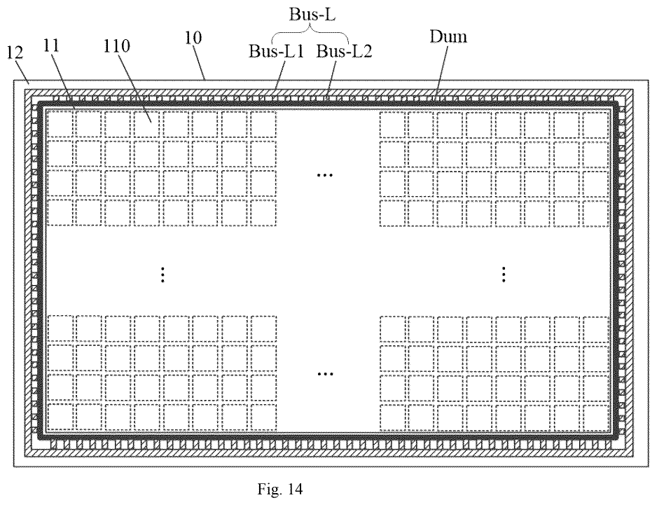

Referring to FIGS. 1, 4, 7, 10 and 14, the present disclosure provides in some embodiments a display substrate, which includes a base substrate 10, and a plurality of touch electrode blocks 110, a plurality of dummy subpixels Dum and a common signal bus Bus-L arranged on the base substrate 10. An orthogonal projection of the dummy subpixel Dum onto the base substrate 10 is located between an orthogonal projection of the common signal bus Bus-L onto the base substrate 10 and an orthogonal projection of the touch electrode block 110 onto the base substrate 10, the dummy subpixel Dum includes a dummy common electrode pattern Dum1, and the dummy common electrode pattern Dum1 is coupled to the common signal bus Bus-L (including a bus body Bus-L1 and a bus extension member Bus-L2).

For example, the display substrate includes a touch region 11 and a peripheral region 12 surrounding the touch region 11.

For example, the touch electrode block 110s is arranged at the touch region 11, and the dummy subpixel Dum and the common signal bus Bus-L are arranged at the peripheral region 12. The common signal bus Bus-L is used to transmit a common signal.

For example, the plurality of touch electrode blocks 110 is arranged in an array form, and the common signal bus Bus-L at least partially surrounds the plurality of touch electrode blocks 110. In a possible embodiment of the present disclosure, the common signal line Bus-L completely surrounds the touch electrodes 110. Taking a rectangular display substrate as an example, the peripheral region 12 includes an upper bezel region, a lower bezel region, a left bezel region and a right bezel region. In at last one bezel region of the upper bezel region, the lower bezel region, the left bezel region and the right bezel region, the orthogonal projection of the dummy subpixel Dum onto the base substrate is located between the orthogonal projection of the common signal bus Bus-L onto the base substrate and the orthogonal projection of the touch electrode block 110 onto the base substrate. It should be appreciated that, the technical solution provide din the embodiment of the present disclosure may be applied to at least one bezel region of the upper bezel region, the lower bezel region, the left bezel region and the right bezel region. Further, the technical solution provided in the embodiments of the present disclosure may be applied to the left bezel region and the right bezel region.

For example, the display substrate further includes a plurality of touch signal lines Tx, and each of the touch signal lines Tx is coupled to a corresponding touch electrode block 110 and configured to provide a common signal to the touch electrode block 110 within a touch time period.

For example, the dummy subpixel Dum includes a dummy common electrode pattern Dum1, and the dummy common electrode pattern Dum1 is coupled to the common signal bus Bus-L and receives the common signal transmitted by the common signal bus Bus-L.

Based on the above-mentioned specific structure of the display substrate, in the embodiments of the present disclosure, the dummy subpixel Dum includes the dummy common electrode pattern Dum1, and the dummy common electrode pattern Dum1 is coupled to the common signal bus Bus-L, so that the dummy common electrode pattern Dum1 has a same potential as the common signal transmitted by the common signal bus Bus-L. In a case that the display substate is within the touch time period, the touch electrode blocks 110 in the display substrate receive the common signal through the respective touch signal lines. In this way, no matter whether the touch electrode block 110 is located in the middle of the display substrate or located proximate to an edge of the display substrate, a structure surrounding each touch electrode block 110 has a same potential as the common signal, and the touch electrode blocks in the display substrate are all in a same electrical environment, i.e., loads surrounding the touch electrode blocks in the display substrate are consistent, so it is able to improve the touch uniformity of the display substrate, and improve the display quality.

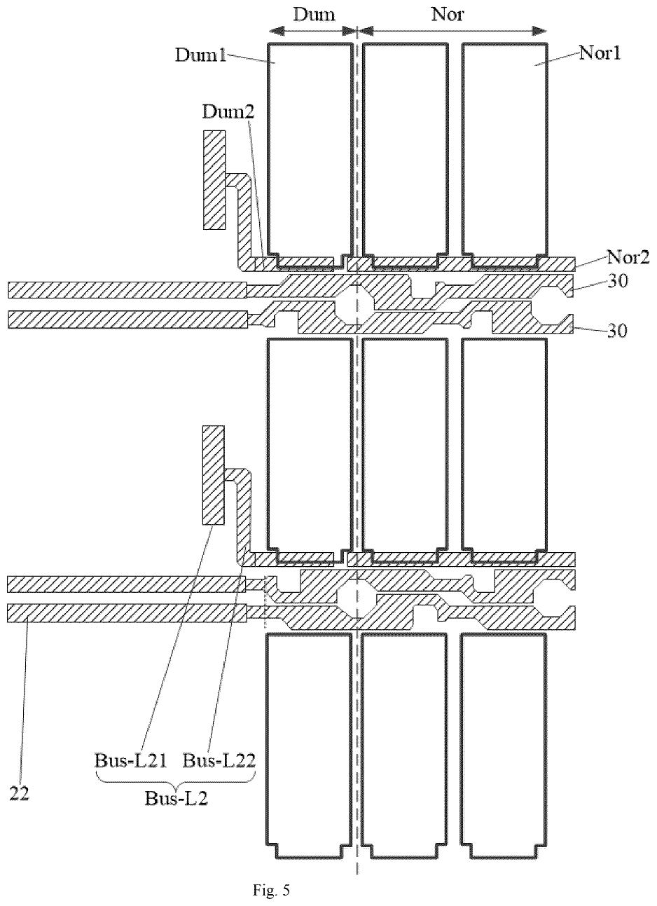

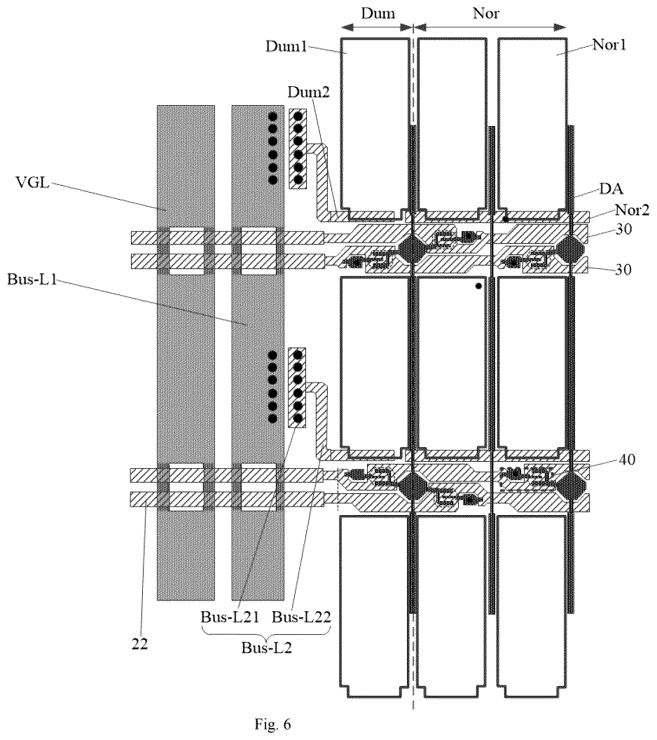

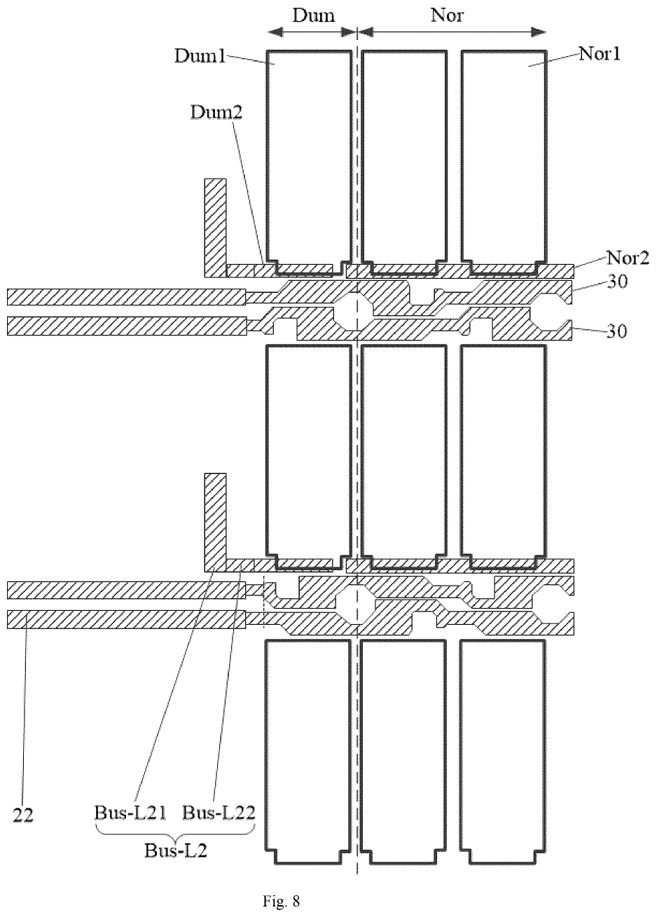

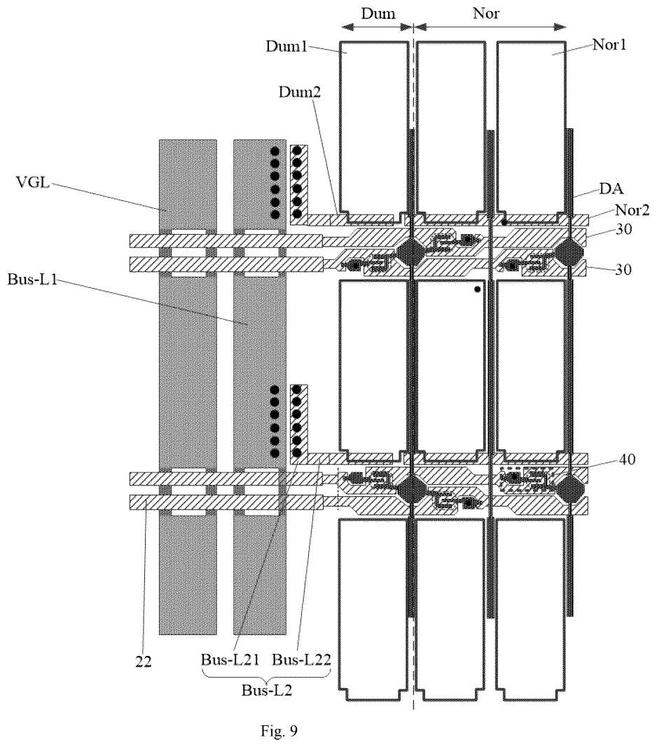

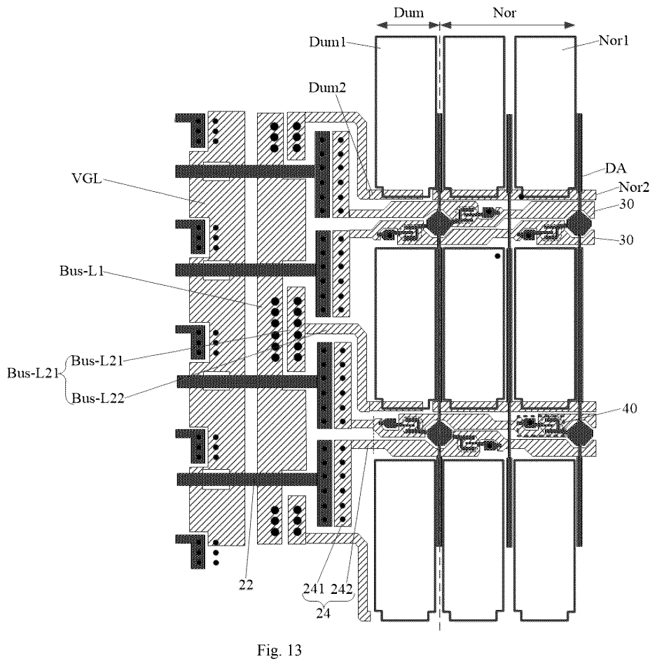

As shown in FIGS. 1 to 14, in some embodiments of the present disclosure, the common signal bus Bus-L includes a bus body Bus-L1 and a plurality of bus extension members Bus-L2 coupled to the bus body Bus-L1. Each of the bus extension member Bus-L2 is coupled to the dummy common electrode pattern Dum1 in a corresponding dummy subpixel Dum.

It should be appreciated that, black dots in the drawings indicate positions where via-holes are formed, and VGL represents a first level signal line.

For example, at least a part of the bus body Bus-L1 surrounds the touch region 11. For example, the bus body Bus-L1 completely surrounds the touch region 11.

For example, the bus body Bus-L1 is arranged at a same layer as the bus extension member Bus-L2, or the bus body Bus-L1 is arranged at a layer different from the bus extension member Bus-L2.

For example, the bus body Bus-L1 and the bus extension member Bus-L2 form an integral piece.

For example, the bus body Bus-L1 is directly coupled to the bus extension member Bus-L2, or the bus body Bus-L1 is indirectly coupled to the bus extension member Bus-L2.

Based on the above, the bus extension member Bus-L2 is coupled to the bus body Bus-L1 and the dummy common electrode pattern Dum1 in the dummy subpixel Dum, and it is able to achieve an electrical connection between the bus body Bus-L1 and the dummy common electrode pattern Dum1 more easily through changing a shape of the bus extension member Bus-L2, thereby to effectively reduce a layout difficulty of the common signal bus.

As shown in FIGS. 1 to 3, in some embodiments of the present disclosure, the bus body Bus-L1 and the bus extension member Bus-L2 form an integral piece, and the bus extension member Bus-L2 is directly lapped onto the dummy common electrode pattern Dum1 in the corresponding dummy subpixel Dum.

As shown in FIG. 11, for example, the display substrate includes a first conductive layer, a gate metal layer, a gate insulation layer GI, an active layer ACT, a source/drain metal layer, a passivation layer PVX and a second conductive layer formed sequentially in a direction away from the base substrate 10. The gate insulation layer is formed without a mask, and it is formed as an entire surface. In FIGS. 11, 401 represents a first electrode of a transistor, and 402 represents a second electrode of the transistor.

For example, the bus body Bus-L1 and the bus extension member Bus-L2 are arranged at a same layer, and made of a same material, as the gate metal layer.

For example, the first conductive layer and the second conductive layer are made of, but not limited to, indium tin oxide.

For example, the first conductive layer includes the dummy common electrode pattern Dum1 and a normal common electrode pattern Nor1. The second conductive layer includes a dummy pixel electrode pattern Dum3 in the dummy subpixel Dum and a normal pixel electrode pattern Nor3 in the normal subpixel Nor. The second conductive layer further includes a conductive connection member.

Based on the above, the bus body Bus-L1 and the bus extension member Bus-L2 form an integral piece, so that the bus body Bus-L1 and the bus extension member Bus-L2 are formed simultaneously through a single patterning process. In this way, it is able to effectively simplify a manufacture process of the display substrate, thereby to reduce the manufacture cost of the display substrate.

Based on the above, the bus extension member Bus-L2 is directly lapped onto the dummy common electrode pattern Dum1 in the dummy subpixel Dum, so it is able to not only ensure the connection performance between the bus extension member Bus-L2 and the dummy common electrode pattern Dum1 in the corresponding dummy subpixel Dum, but also simplify the manufacture process of the display substrate and reduce the manufacture of the display substrate.

As shown in FIGS. 1 to 3, in some embodiments of the present disclosure, the dummy subpixel Dum further includes a dummy common electrode line Dum2, and the dummy common electrode line Dum2 is coupled to an end of the dummy common electrode pattern Dum1. The dummy common electrode pattern Dum1 extends in a first direction, a first end of the dummy common electrode line Dum2 and a first end of the bus extension member Bus-L2 are arranged in the first direction, the first end of the dummy common electrode line Dum2 is an end of the dummy common electrode line Dum2 proximate to the bus body Bus-L1, and the first end of the bus extension member Bus-L2 is an end of the bus extension member Bus-L2 distal to the bus body Bus-L1.

For example, the dummy common electrode line Dum2 is arranged at a same layer, and made of a same material, as the gate metal layer, and the dummy common electrode line Dum2 is directly lapped onto an end of the dummy common electrode pattern Dum1.

For example, a distance between the first end of the dummy common electrode line Dum2 and the first end of the bus extension member Bus-L2 is greater than or equal to one third of a length of the dummy common electrode pattern Dum1 in the first direction. For example, the distance between the first end of the dummy common electrode line Dum2 and the first end of the bus extension member Bus-L2 is equal to a half of the length of the dummy common electrode pattern Dum1 in the first direction.

Based on the above, the first end of the dummy common electrode line Dum2 and the first end of the bus extension member Bus-L2 are arranged in the first direction, so that the first end of the dummy common electrode line Dum2 is staggered with the first end of the bus extension member Bus-L2. In this way, it is able to prevent the occurrence of point discharging at the first end of the dummy common electrode line Dum2 and the first end of the bus extension member Bus-L2, thereby to ensure the operating stability of the display substrate.

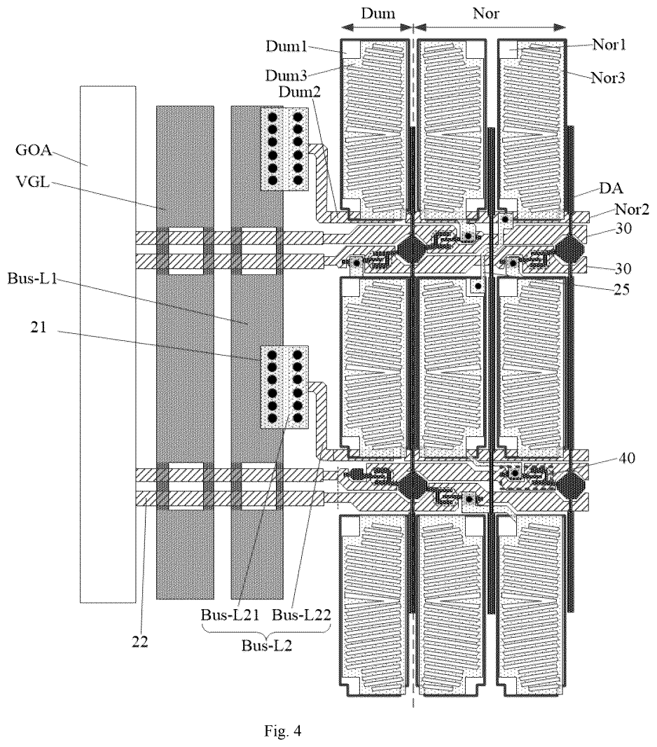

As shown in FIGS. 4 to 13, in some embodiments of the present disclosure, the bus body Bus-L1 is coupled to the bus extension member Bus-L2 through a first conductive connection member 21. The dummy subpixel Dum further includes a dummy common electrode line Dum2, the dummy common electrode line Dum2 is coupled to an end of the dummy common electrode pattern Dum1, and the bus extension member Bus-L2 is coupled to the dummy common electrode line Dum2 in a corresponding dummy subpixel Dum.

For example, the bus body Bus-L1 is arranged at a same layer as, or at a layer different from, the bus extension member Bus-L2, and the first conductive connection member 21 is arranged at a layer different from each of the bus body Bus-L1 and the bus extension member Bus-L2. For example, the bus body Bus-L1 and the bus extension member Bus-L2 are arranged at a same layer as, and made of a same material, as the gate metal layer, and the first conductive connection member 21 is arranged at a same layer, and made of a same material, as the first conductive layer. For example, the bus body Bus-L1 is arranged at a same layer, and made of a same material, as the source/drain metal layer, the bus extension member Bus-L2 is arranged at a same layer, and made of a same material, as the gate metal layer, and the first conductive connection member 21 is arranged at a same layer, and made of a same material, as the first conductive layer.

For example, there is an overlapping region between an orthogonal projection of the first conductive connection member 21 onto the base substrate and an orthogonal projection of the bus body Bus-L1 onto the base substrate. At the overlapping region, the first conductive connection member 21 is coupled to the bus body Bus-L1 through a via-hole. There is an overlapping region between the orthogonal projection of the first conductive connection member 21 onto the base substrate and an orthogonal projection of the bus extension member Bus-L2 onto the base substrate. At the overlapping region, the first conductive connection member 21 is coupled to the bus extension member Bus-L2 through a via-hole.

For example, the bus extension member Bus-L2 is coupled to the dummy common electrode line Dum2 in the corresponding dummy subpixel Dum. Through the dummy common electrode line Dum2, an electrical connection is achieved between the bus extension member Bus-L2 and the corresponding dummy common electrode pattern Dum1.

Based on the above, the bus body Bus-L1 is coupled to the bus extension member Bus-L2 through the first conductive connection member 21, so as to prevent a risk of point discharging caused in a case that the bus body Bus-L1 is directly coupled to the thinner bus extension member Bus-L2.

As shown in FIGS. 4 to 13, in some embodiments of the present disclosure, the bus extension member Bus-L2 includes a first extension portion Bus-L21 and a second extension portion Bus-L22 coupled to each other. An extension direction of the first extension portion Bus-L21 is the same as an extension direction of the bus body Bus-L1 proximate to the first extension portion Bus-L21, and an orthogonal projection of the first extension portion Bus-L21 onto the base substrate and an orthogonal projection of the bus body Bus-L1 onto the base substrate are arranged in a direction intersecting the extension direction of the bus body Bus-L1 proximate to the first extension portion. The second extension portion Bus-L22 is coupled to the dummy common electrode line Dum2 in a corresponding dummy subpixel Dum. The first conductive connection member 21 is coupled to the bus body Bus-L1 and the first extension portion Bus-L21.

For example, the first extension portion Bus-L21 and the second extension portion Bus-L22 form an integral piece.

For example, the second extension portion Bus-L22 is coupled to an end of the first extension portion Bus-L21, or the second extension portion Bus-L22 is coupled to a middle portion of the first extension portion Bus-L21.

For example, the first direction intersects the second direction, the first direction includes a longitudinal direction, and the second direction includes a transverse direction. However, the present disclosure is not limited thereto.

For example, there is an overlapping region between the orthogonal projection of the first conductive connection member 21 onto the base substrate and the orthogonal projection of the first extension portion Bus-L21 onto the base substrate, and at the overlapping region, the first conductive connection member 21 is coupled to the first extension portion Bus-L21 through a via-hole.

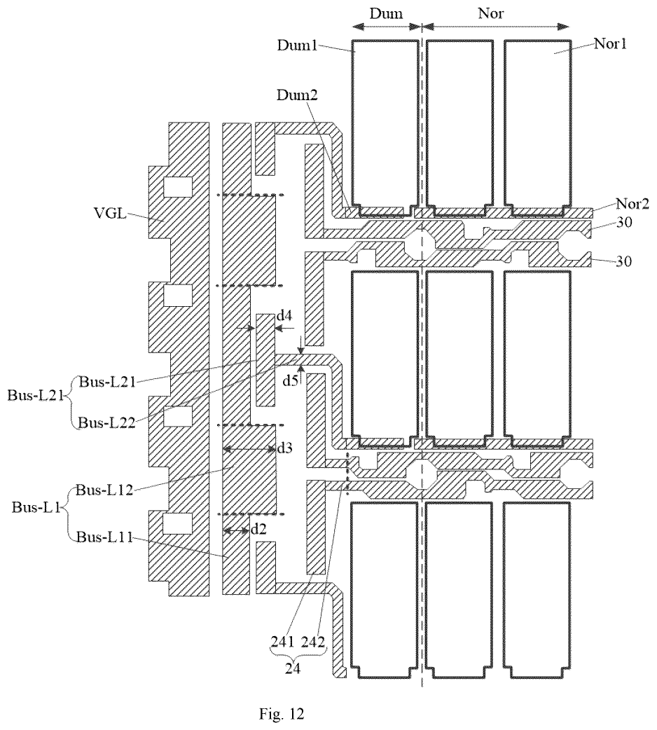

As shown in FIG. 12, for example, a width d4 of the first extension portion Bus-L21 in a direction perpendicular to its extension direction is greater than a width d5 of the second extension portion Bus-L22 in a direction perpendicular to its extension direction.

Based on the above, it is able to not only ensure the connection stability between the bus body Bus-L1 and the bus extension member Bus-L2, but also increase an overlapping area between the bus body Bus-L1 and the bus extension member Bus-L2, thereby to effectively eliminate the risk of point discharging between the bus body Bus-L1 and the bus extension member Bus-L2.

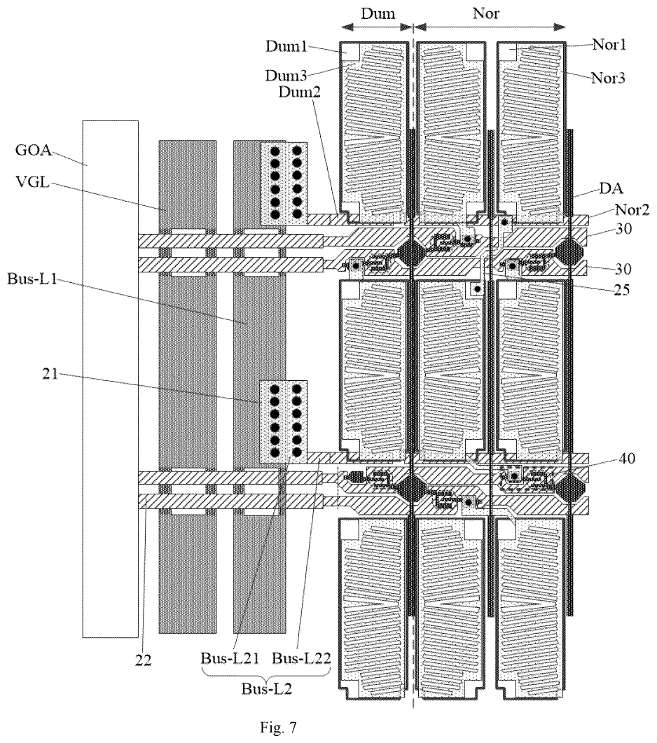

As shown in FIGS. 7 to 9, in some embodiments of the present disclosure, an extension direction of the second extension portion Bus-L22 is the same as an extension direction of the dummy common electrode line Dum2.

For example, the second extension portion Bus-L22 and the dummy common electrode line Dum2 both extend in a direction intersecting the extension direction of the bus body Bus-L1 proximate thereto.

Based on the above, the first extension portion Bus-L21 and the second extension portion Bus-L22 are arranged more proximate to the dummy common electrode line Dum2, so as to effectively reduce the layout difficulty while ensuring that the bus extension member Bus-L2 is coupled to the dummy common electrode line Dum2.

In some embodiments of the present disclosure, the extension direction of the second extension portion Bus-L22, e.g., the second extension portion at the upper bezel region or the lower bezel region of the display substrate, is the same as the extension direction of the dummy common electrode pattern Dum1.

As shown in FIGS. 4 to 6, in some embodiments of the present disclosure, the second extension portion Bus-L22 includes at least two sub-portions coupled sequentially, and extension directions of two sub-portions proximate to each other are different.

For example, the second extension portion Bus-L22 includes a first sub-portion, a second sub-portion and a third sub-portion coupled sequentially, each of the first sub-portion and the second sub-portion extends in a direction intersecting the extension direction of the bus body Bus-L1 proximate thereto, and an extension direction of the second sub-portion is the same as an extension direction of the bus body Bus-L1 proximate to the second sub-portion.

Based on the above, it is able to flexibly set a specific shape of the bus extension member Bus-L2 in accordance with a surrounding structure, thereby to effectively reduce the layout difficulty while ensuring that the bus extension member Bus-L2 is coupled to the corresponding dummy common electrode line Dum2.

As shown in FIGS. 4 to 9, in some embodiments of the present disclosure, the display substrate further includes a gate metal layer and a source/drain metal layer, the bus body Bus-L1 is arranged at a same layer, and made of a same material, as the source/drain metal layer, and the bus extension member Bus-L2 is arranged at a same layer, and made of a same material, as the gate metal layer.

Based on the above arrangement, the bus body Bus-L1 and the source/drain metal layer are formed through a single patterning process, and the bus extension member Bus-L2 and the gate metal layer are formed through a single patterning process, so it is able to effectively simplify the manufacture process of the display substrate, and reduce the manufacture cost.

As shown in FIGS. 1 to 3 and 10 to 12, in some embodiments of the present disclosure, the display substrate further includes a gate metal layer, and the bus body Bus-L1 and the bus extension member Bus-L2 are arranged at a same layer, and made of a same material, as the gate metal layer.

Based on the above arrangement, the bus body Bus-L1 and the bus extension member Bus-L2 are formed through a single patterning process with the gate metal layer, so it is able to effectively simplify the manufacture process of the display substrate, and reduce the manufacture cost.

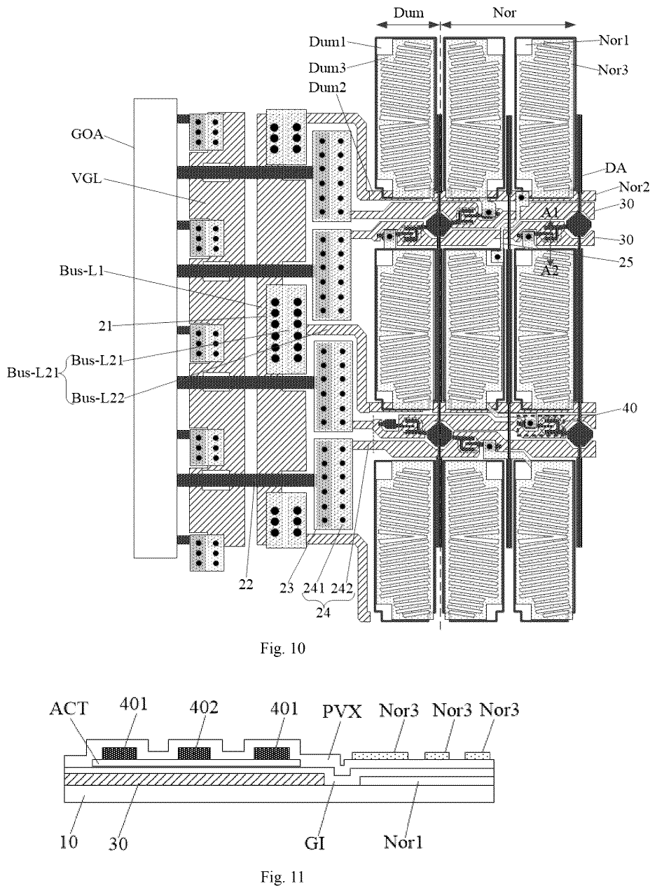

As shown in FIGS. 10 to 13, in some embodiments of the present disclosure, in a case that the bus extension member Bus-L2 includes the first extension portion Bus-L21 and the second extension portion Bus-L22 coupled to each other, the bus body Bus-L1 includes first bus portions Bus-L11 and second bus portions Bus-L12 arranged alternately, a width d2 of the first bus portion Bus-L11 is smaller than a width d3 of the second bus portion Bus-L12 in a direction perpendicular to an extension direction of the bus body, and the first bus portion Bus-L11 and the first extension portion Bus-L21 are arranged in the direction perpendicular to the extension direction of the bus body.

For example, an orthogonal projection of the second bus portion Bus-L12 onto the base substrate and the orthogonal projection of the first extension portion Bus-L21 onto the base substrate are arranged in a direction parallel to the bus body Bus-L1 proximate thereto.

For example, an orthogonal projection of a boundary of the second bus portion Bus-L12 facing the touch region 11 onto the base substrate is flush with an orthogonal projection of a boundary of the first extension portion Bus-L21 facing the touch region 11 onto the base substrate. However, the present disclosure is not limited thereto.

For example, in a case that the first extension portion Bus-L21 is arranged at a same layer, and made of a same material, as the bus body Bus-L1, a minimum distance between the two is greater than or equal to 5 μm, e.g., 8 μm. However, the present disclosure is not limited thereto.

Based on the above arrangement, it is able to provide a narrow-bezel display substrate, and meanwhile reduce the layout difficulty of the display substrate in a limited layout space.

As shown in FIGS. 10 to 13, in some embodiments of the present disclosure, the display substrate further includes: a gate driving circuit GOA and a plurality of scanning lines 30, at least a part of an orthogonal projection of the bus body Bus-L1 onto the base substrate being located between an orthogonal projection of the gate driving circuit GOA onto the base substrate and orthogonal projections of the plurality of scanning lines 30 onto the base substrate; a plurality of second conductive connection members 22, an orthogonal projection of each of the second conductive connection members 22 onto the base substrate partially overlapping with the orthogonal projection of the bus body Bus-L1 onto the base substrate, the plurality of second connection members 22 being coupled to the gate driving circuit GOA; and a plurality of third conductive connection members 23 and a plurality of fourth conductive connection members 24, each of the third conductive connection members 23 being coupled to a corresponding second conductive connection member 22 and a corresponding fourth conductive connection member 24, each of the fourth conductive connection members 24 and a corresponding scanning line 30 forming an integral piece.

For example, the gate driving circuit GOA is arranged, but not limited to, at a left bezel and/or a right bezel of the display substrate.

For example, the display product adopts a dual-gate-line control structure, i.e., the normal subpixels Nor in a same row are controlled by two scanning lines 30. For example, in the normal subpixels Nor in a same row, odd-numbered normal subpixels Nor are controlled by one scanning line 30, and even-numbered normal subpixels Nor are controlled by another scanning line 30.

For example, the normal subpixel Nor includes a normal common electrode pattern Nor1 and a normal pixel electrode pattern Nor3 arranged opposite to each in a direction perpendicular to the base substrate, and further includes a normal control circuit 40. The normal control circuit 40 is coupled to a corresponding scanning line 30, a corresponding data line DA and the normal pixel electrode pattern Nor3, and configured to control the data line D1 to be electrically coupled to the normal pixel electrode pattern Nor3 under the control of the scanning line 30.

For example, the normal control circuit 40 includes a control transistor, a gate electrode of the control transistor is coupled to the corresponding scanning line 30, a first electrode of the control transistor is coupled to the corresponding data line DA, and a second electrode of the control transistor is coupled to the corresponding normal pixel electrode.

For example, the dummy subpixel Dum includes a dummy common electrode pattern Dum1 and a dummy pixel electrode pattern Dum3 arranged opposite to each other in a direction perpendicular to the base substrate, and further includes a dummy control circuit coupled to a corresponding scanning line 30 and a corresponding data line DA.

For example, the dummy control circuit includes a control transistor, a gate electrode of the control transistor is coupled to the corresponding scanning line 30, a first electrode of the transistor is coupled to the corresponding data line DA, a portion of a second electrode of the control transistor is coupled to the corresponding dummy pixel electrode, and another portion of the second electrode of the control transistor is in a floating state.

For example, the display substrate further includes a liquid crystal layer, and liquid crystals in the liquid crystal layer are deflected under the effect of the normal common electrode pattern Nor1 and the normal pixel electrode pattern Nor3 in the normal subpixel Nor, so as to achieve a display function.

For example, the second conductive connection member 22 is arranged at a layer different from the bus body Bus-L1. The bus body Bus-L1 includes a hollowed-out region, and at least a part of the second conductive connection member 22 is arranged at the hollowed-out region. Based on the above arrangement, it is able to reduce a parasitic capacitance between the second conductive connection member 22 and the bus body Bus-L1.

For example, the second conductive connection member 22 is arranged at a same layer, and made of a same material, as the source/drain metal layer, the third conductive connection member 23 is arranged at a same layer, and made of a same material, as the first conductive layer, and the fourth conductive connection member 24 is arranged at a same layer, and made of a same material, as the gate metal layer.

For example, there is an overlapping region between an orthogonal projection of the third conductive connection member 23 onto the base substrate and the orthogonal projection of the second conductive connection member 22 onto the base substrate, and the third conductive connection member 23 is coupled to the second conductive connection member 22 through a via-hole in the overlapping region. There is an overlapping region between the orthogonal projection of the third conductive connection member 23 onto the base substrate and an orthogonal projection of the fourth conductive connection member 24 onto the base substrate, and the third conductive connection member 23 is coupled to the fourth conductive connection member 24 through a via-hole in the overlapping region.

As shown in FIGS. 10 to 13, for example, the fourth conductive connection member 24 includes a first conductive portion 241 and a second conductive portion 242 coupled to each other, an extension direction of the first conductive connection portion 241 is the same as an extension direction of the bus body Bus-L1 proximate to the first conductive portion 241, an orthogonal projection of the first conductive portion 241 onto the base substrate and the orthogonal projection of the second conductive connection member 22 onto the base substrate are arranged in a direction intersecting the extension direction of the bus body Bus-L1 proximate to the first conductive portion, and the second conductive portion 242 extends in a direction intersecting the extension direction of the bus body Bus-L1 proximate to the second conductive portion 242. The third conductive connection member 23 is coupled to a corresponding second conductive connection member 22 and the first conductive portion 241, and the second conductive portion 242 and a corresponding scanning line 30 form an integral piece.

For example, an extension direction of the second conductive portion 242 is the same as an extension direction of the scanning line 30.

For example, the first conductive portion 241 and the second conductive portion 242 form an integral piece.

Based on the above arrangement, it is able to ensure the connection reliability between the second conductive connection member 22 and the fourth conductive connection member 24, and increase an overlapping area between the second conductive connection member 22 and the fourth conductive connection member 24, thereby to prevent the occurrence of point discharging.

As shown in FIGS. 10 to 13, in some embodiments of the present disclosure, in some embodiments of the present disclosure, at least a part of the orthogonal projection of the first conductive portion 241 onto the base substrate is located between an orthogonal projection of the first extension portion Bus-L21 onto the base substrate and an orthogonal projection of the dummy common electrode pattern Dum1 onto the base substrate. The orthogonal projection of the first conductive portion 241 onto the base substrate and at least a part of an orthogonal projection of the second extension portion Bus-L22 onto the base substrate are arranged in the extension direction of the bus body proximate to the first conductive portion. At least a part of the orthogonal projection of the first conductive portion 241 onto the base substrate and at least a part of the orthogonal projection of the second extension portion Bus-L22 onto the base substrate are arranged in a direction intersecting the extension direction of the bus body Bus-L1 proximate to the first conductive portion.

As shown in FIG. 10, for example, the second extension portion Bus-L22 includes a first sub-portion, a second sub-portion and a third sub-portion coupled sequentially, and the orthogonal projection of the first conductive portion 241 onto the base substrate and at least a part of an orthogonal projection of the first sub-portion onto the base substrate are arranged in the extension direction of the bus body proximate to the first conductive portion. At least a part of the orthogonal projection of the first conductive portion 241 onto the base substrate and at least a part of the orthogonal projection of the second sub-portion onto the base substrate are arranged in a direction intersecting the extension direction of the bus body Bus-L1 proximate thereto.

Based on the above arrangement, the bus extension member Bus-L2 bypasses the third conductive connection member 23 and the fourth conductive connection member 24, so as to reduce the layout difficulty of the display substrate while ensuring that there is a sufficient layout space for the bus extension member Bus-L2, the third conductive connection member 23 and the fourth conductive connection member 24.

As shown in FIGS. 4 to 9, in some embodiments of the present disclosure, the display substrate further includes: a gate driving circuit GOA and a plurality of scanning lines 30, at least a part of an orthogonal projection of the bus body Bus-L1 onto the base substrate being located between an orthogonal projection of the gate driving circuit GOA onto the base substrate and orthogonal projections of the plurality of scanning lines 30 onto the base substrate; and a plurality of second conductive connection members 22, an orthogonal projection of each of the second conductive connection members 22 onto the base substrate partially overlapping with an orthogonal projection of the bus body Bus-L1 onto the base substrate, the plurality of second conductive connection members 22 being coupled to the gate driving circuit GOA, and the second conductive connection member 22 and a corresponding scanning line 30 forming an integral piece.

For example, each of the second conductive connection member 22 and the corresponding scanning line 30 is arranged at a same layer, and made of a same material, as the gate metal layer.

Based on the above arrangement, it is able to provide the display substrate with a narrow bezel, and reduce the layout difficulty of the bezel of the display substrate.

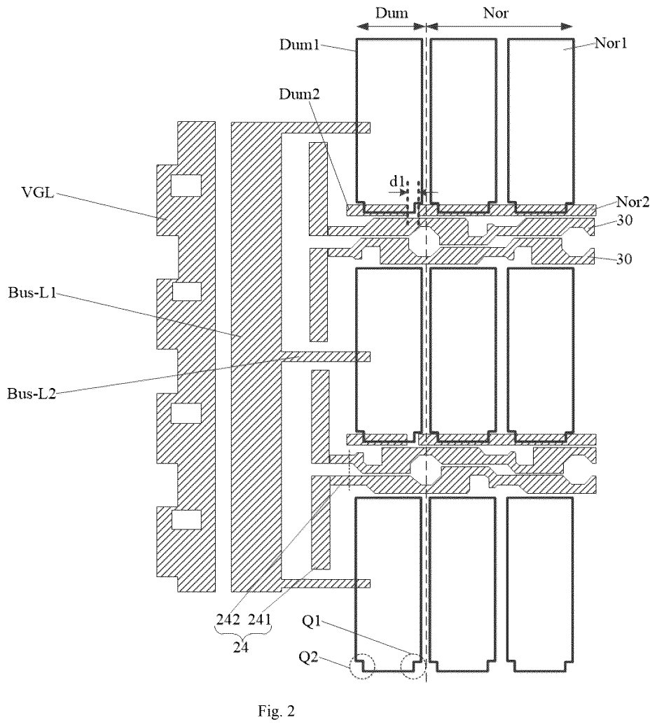

As shown in FIGS. 1 to 3, in some embodiments of the present disclosure, the display substrate further includes a plurality of normal subpixels Nor, and each of the normal subpixels Nor includes a normal common electrode pattern Nor1. A plurality of normal common electrode patterns Nor1 included in the plurality of normal subpixels Nor is grouped into a plurality of touch electrode blocks 110, each of the touch electrode blocks 110 includes at least two normal common electrode patterns Nor1, and in a same touch electrode block 110, the normal common electrode patterns Nor1 arranged in a second direction are coupled to each other through a normal common electrode line Nor2. The dummy subpixel Dum further includes a dummy common electrode line Dum2, and a gap is provided between the dummy common electrode line Dum2 and the normal common electrode line Nor2 proximate to the dummy common electrode line in the second direction (as shown in FIG. 2, the gap has a width of d1).

For example, the touch electrode block 110 includes a plurality of normal common electrode patterns Nor1 arranged in an array form. In a same touch electrode block 110, the normal common electrode patterns Nor1 arranged in a same row in a direction intersecting the extension direction of the bus body Bus-L1 proximate thereto are coupled to each other through a corresponding normal common electrode line Nor2, and two rows of normal common electrode patterns Nor1 proximate to each other in the first direction are coupled to each other through a fifth conductive connection member 25.

For example, the normal common electrode pattern Nor1 is reused as the touch electrode block 110, and the dummy common electrode pattern Dum1 is not reused as the touch electrode block 110.

A width d1 of a gap between the dummy common electrode line Dum2 and the normal common electrode line Nor2 proximate to the dummy common electrode line in a direction intersecting with the extension direction of the bus body Bus-L1 proximate thereto is greater than or equal to 10 μm.

Based on the above, there is the gap between the dummy common electrode line Dum2 and the normal common electrode line Nor2 proximate to the dummy common electrode line in the direction intersecting with the extension direction of the bus body Bus-L1 proximate thereto, so it is able to prevent the occurrence of point discharging between the dummy common electrode line Dum2 and the normal common electrode line Nor2, thereby to prevent the occurrence of a short-circuit between the dummy common electrode line Dum2 and the normal common electrode line Nor2.

There is a gap between the normal common electrode lines Nor2 proximate to each other in the second direction, and a width of the gap is greater than or equal to 10 μm. Based on the above arrangement, it is able to prevent the occurrence of point discharging between the normal common electrode lines Nor2 proximate to each other in the second direction, thereby to prevent the occurrence of a short-circuit between the normal common electrode lines Nor2.

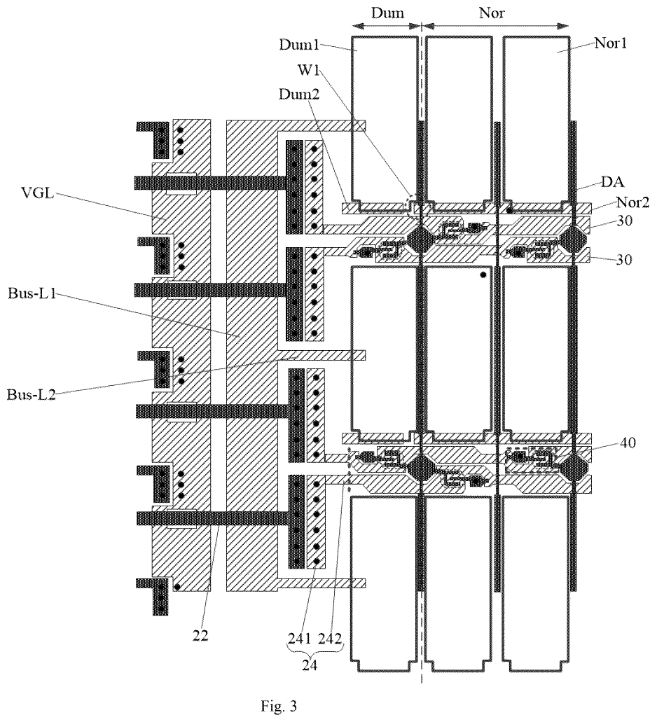

As shown in FIGS. 1 to 13, in some embodiments of the present disclosure, the display substrate further includes a plurality of data lines DA, and an orthogonal projection of each of the data line DA1 onto the base substrate partially overlaps with an orthogonal projection of the normal common electrode line Nor2 onto the base substrate (e.g., at a position W1 in FIG. 3).

For example, the data line DA1 is arranged at a same layer, and made of a same material, as the source/drain metal layer.

For example, the quantity of normal common electrode lines Nor2 overlapping with each data line DA is the same.

For example, the orthogonal projection of the data line DA onto the base substrate does not overlap with an orthogonal projection of the dummy common electrode Dum2 onto the base substrate.

For example, the orthogonal projection of the data line DA proximate to the dummy subpixel Dum onto the base substrate at least partially overlaps with the orthogonal projection of the normal common electrode line Nor2 coupled to the normal common electrode pattern Nor1 in the touch electrode block 110 proximate thereto onto the base substrate. An orthogonal projection of a first portion of the normal common electrode line Nor2 onto the base substrate is located between the orthogonal projection of the data line DA onto the base substrate and the orthogonal projection of the bus body Bus-L1 onto the base substrate, and a length of the first portion in the second direction is greater than or equal to 4 μm.

For example, the dummy control circuit included in the dummy subpixel has a same structure as the normal control circuit 40 included in the normal subpixel Nor.

Based on the above arrangement, a same load is formed between each data line DA and the surrounding gate metal layer, so it is able to effectively maintain the image quality uniformity of the display substrate.

As shown in FIGS. 1 to 3, in some embodiments of the present disclosure, the dummy subpixel Dum further includes a dummy common electrode line Dum2, an end of the dummy common electrode pattern Dum1 coupled to the dummy common electrode line Dum2 includes a first notch Q1, and the first notch Q1 is arranged proximate to the normal common electrode line Nor2.

There is no medium between the dummy common electrode line Dum2 and the normal common electrode line Nor2, so a distance greater than or equal to 6 μm is maintained between the dummy common electrode line Dum2 and the normal common electrode line Nor2 to prevent the occurrence of short-circuit. The above distance is achieved through setting the first notch Q1.

As shown in FIGS. 1 to 3, in some embodiments of the present disclosure, the end of the dummy common electrode pattern Dum 1 coupled to the dummy common electrode line Dum2 further includes a second notch Q2, and the second notch Q2 is arranged opposite to the first notch Q1 in the second direction.

Based on the above arrangement, it is able to achieve the symmetry of the dummy common electrode pattern Dum1 in the second direction. In addition, in a case that the normal common electrode pattern Nor1 has the first notch Q1 and the second notch Q2, it is able to improve the uniformity of the display substrate.

An end of the dummy common electrode pattern Dum1 distal to the dummy common electrode line Dum2 is not provided with any notch, and an end of the normal common electrode pattern Nor1 distal to the normal common electrode line Nor2 is not provided with any notch, so as to increase an area of the common electrode pattern, thereby to improve an aperture ratio of the display substrate.

In order to ensure that all the subpixels have a same charging capability and a same load, in the dummy subpixels and the normal subpixels, the common electrode patterns have a same structure, and the pixel electrode patterns have a same structure. The common electrode pattern and the common electrode line are both used to transmit a common signal, and they are directly lapped one onto another. At a boundary between two touch electrode blocks proximate to each other, and at a boundary between the dummy subpixel and the touch electrode block, the common electrode line made of the gate metal layer is formed, and the pixel electrode pattern covers the common electrode lines, so as to ensure that the subpixels surrounding the boundaries have a same pixel storage capacitance, thereby to ensure a same charging ratio for the pixels as well as uniform image quality.

The present disclosure further provides in some embodiments a display substrate, which includes the above-mentioned display substrate.

For example, the display device includes, but not limited to, a liquid crystal display device.

It should be appreciated that, the display device may be any product or member having a display function, e.g., television, display, digital photo frame, mobile phone or tablet computer. The display device further includes a flexible circuit board, a printed circuit board and a back plate.

In the display substrate provided in the embodiments of the present disclosure, the dummy subpixel includes the dummy common electrode pattern, and the dummy common electrode pattern is coupled to the common signal bus, so that the dummy common electrode pattern has a same potential as the common signal transmitted by the common signal bus. In a case that the display substate is within the touch time period, the touch electrode blocks in the display substrate receive the common signal through the respective touch signal lines. In this way, no matter whether the touch electrode block is located in the middle of the display substrate or located proximate to an edge of the display substrate, a structure surrounding each touch electrode block has a same potential as the common signal, and the touch electrode blocks in the display substrate are all in a same electrical environment, i.e., loads surrounding the touch electrode blocks in the display substrate are consistent, so it is able to improve the touch uniformity of the display substrate, and improve the display quality.

In a case that the display device in the embodiments of the present disclosure includes the above-mentioned display substrate, it also has the above-mentioned beneficial effects, which will not be particularly defined herein.

It should be appreciated that, in the case that a signal line extends along a direction X, it means that a primary portion of the signal line, e.g., a line, a segment or a strip-like body, extends along the direction X, and an extension length of the primary portion is greater than an extension length of a secondary portion of the signal line, which is coupled to the primary portion, in the other direction.

It should be further appreciated that, the expression “at a same layer” refers to that the film layers are arranged on a same structural layer. Alternatively, for example, the film layers on a same layer may be layer structures formed through forming thin layers for forming specific patterns through a single-film-forming process and then patterning the film layers with a same mask through a single patterning process. Depending on different specific patterns, a single patterning process may include multiple exposing, development or etching processes, and the specific patterns in the layer structure may be continuous or discontinuous. These specific patterns may also be arranged at different levels or have different thicknesses.

In the embodiments of the present disclosure, the order of the steps is not limited to the serial numbers thereof. For a person skilled in the art, any change in the order of the steps shall also fall within the scope of the present disclosure if without any creative effort.

It should be further appreciated that, the above embodiments have been described in a progressive manner, and the same or similar contents in the embodiments have not been repeated, i.e., each embodiment has merely focused on the difference from the others. Especially, the method embodiments are substantially similar to the product embodiments, and thus have been described in a simple manner.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

It should be appreciated that, in the case that such an element as layer, film, region or substrate is arranged “on” or “under” another element, it may be directly arranged “on” or “under” the other element, or an intermediate element may be arranged therebetween.

In the above description, the features, structures, materials or characteristics may be combined in any embodiment or embodiments in an appropriate manner.

The above embodiments are merely for illustrative purposes, but shall not be construed as limiting the scope of the present disclosure. Any person skilled in the art may make modifications and substitutions without departing from the spirit of the present disclosure, and these modifications and substitutions shall also fall within the scope of the present disclosure. Hence, the scope of the present disclosure shall be subject to the scope defined by the appended claims.

1. A display substrate, comprising a base substrate, and a plurality of touch electrode blocks, a plurality of dummy subpixels and a common signal bus arranged on the base substrate,
wherein an orthogonal projection of the dummy subpixel onto the base substrate is located between an orthogonal projection of the common signal bus onto the base substrate and an orthogonal projection of the touch electrode block onto the base substrate, the dummy subpixel comprises a dummy common electrode pattern, and the dummy common electrode pattern is coupled to the common signal bus.

2. The display substrate according to claim 1, wherein the common signal bus comprises a bus body and a plurality of bus extension members coupled to the bus body, and each of the bus extension members is coupled to the dummy common electrode pattern in a corresponding dummy subpixel.

3. The display substrate according to claim 2, wherein the bus body and the bus extension members form an integral piece, and the bus extension member is directly lapped onto the dummy common electrode pattern in the corresponding dummy subpixel.

4. The display substrate according to claim 3, wherein the dummy subpixel further comprises a dummy common electrode line, and the dummy common electrode line is coupled to an end of the dummy common electrode pattern;
the dummy common electrode pattern extends in a first direction; and
a first end of the dummy common electrode line and a first end of the bus extension member are arranged in the first direction, the first end of the dummy common electrode line is an end of the dummy common electrode line proximate to the bus body, and the first end of the bus extension member is an end of the bus extension member distal to the bus body.

5. The display substrate according to claim 4, wherein a distance between the first end of the dummy common electrode line and the first end of the bus extension member is greater than or equal to one third of a length of the dummy common electrode pattern in the first direction.

6. The display substrate according to claim 2, wherein the bus body is coupled to the bus extension member through a first conductive connection member, the dummy subpixel further comprises a dummy common electrode line, the dummy common electrode line is coupled to an end of the dummy common electrode pattern, and the bus extension member is coupled to the dummy common electrode line in the corresponding dummy subpixel.

7. The display substrate according to claim 6, wherein the bus extension member comprises a first extension portion and a second extension portion coupled to each other, an extension direction of the first extension portion is the same as an extension direction of the bus body proximate to the first extension portion, and an orthogonal projection of the first extension portion onto the base substrate and an orthogonal projection of the bus body onto the base substrate are arranged in a direction intersecting the extension direction of the bus body proximate to the first extension portion;
the second extension portion is coupled to the dummy common electrode line in the corresponding dummy subpixel; and
the first conductive connection member is coupled to the bus body and the first extension portion.

8. The display substrate according to claim 7, wherein a width of the first extension portion in a direction perpendicular to the extension direction of the first extension portion is greater than a width of the second extension portion in a direction perpendicular to an extension direction of the second extension portion.

9. The display substrate according to claim 7, wherein an extension direction of the second extension portion is the same as an extension direction of the dummy common electrode line; or
the extension direction of the second extension portion is the same as an extension direction of the dummy common electrode pattern; or
the second extension portion comprises at least two sub-portions coupled sequentially, and extension directions of two sub-portions proximate to each other are different.

10. The display substrate according to claim 7, further comprising a gate metal layer and a source/drain metal layer, wherein the bus body is arranged at a same layer, and made of a same material, as the source/drain metal layer, and the bus extension member is arranged at a same layer, and made of a same material, as the gate metal layer.

11. The display substrate according to claim 3, further comprising a gate metal layer, wherein the bus body and the bus extension member are arranged at a same layer, and made of a same material, as the gate metal layer.

12. The display substrate according to claim 11, wherein in a case that the bus extension member comprises a first extension portion and a second extension portion coupled to each other, the bus body comprises first bus portions and second bus portions arranged alternately, a width of the first bus portion is smaller than a width of the second bus portion in a direction perpendicular to an extension direction of the bus body, and the first bus portion and the first extension portion are arranged in the direction perpendicular to the extension direction of the bus body.

13. The display substrate according to claim 12, further comprising:
a gate driving circuit and a plurality of scanning lines, at least a part of an orthogonal projection of the bus body onto the base substrate being located between an orthogonal projection of the gate driving circuit onto the base substrate and orthogonal projections of the plurality of scanning lines onto the base substrate;
a plurality of second conductive connection members, an orthogonal projection of each of the second conductive connection members onto the base substrate partially overlapping with the orthogonal projection of the bus body onto the base substrate, the plurality of second connection members being coupled to the gate driving circuit; and
a plurality of third conductive connection members and a plurality of fourth conductive connection members, each of the third conductive connection members being coupled to a corresponding second conductive connection member and a corresponding fourth conductive connection member, and each of the fourth conductive connection members and a corresponding scanning line forming an integral piece.

14. The display substrate according to claim 13, wherein the fourth conductive connection member comprises a first conductive portion and a second conductive portion coupled to each other, an extension direction of the first conductive connection portion is the same as an extension direction of the bus body proximate to the first conductive portion, an orthogonal projection of the first conductive portion onto the base substrate and an orthogonal projection of the second conductive connection member onto the base substrate are arranged in a direction intersecting the extension direction of the bus body proximate to the first conductive portion, and an extension direction of the second conductive portion is the same as an extension direction of the scanning line; and
the third conductive connection member is coupled to a corresponding second conductive connection member and the first conductive portion, and the second conductive portion and a corresponding scanning line form an integral piece.

15. The display substrate according to claim 14, wherein at least a part of the orthogonal projection of the first conductive portion onto the base substrate is located between an orthogonal projection of the first extension portion onto the base substrate and an orthogonal projection of the dummy common electrode pattern onto the base substrate;
the orthogonal projection of the first conductive portion onto the base substrate and at least a part of an orthogonal projection of the second extension portion onto the base substrate are arranged in the extension direction of the bus body proximate to the first conductive portion; and
at least a part of the orthogonal projection of the first conductive portion onto the base substrate and at least a part of the orthogonal projection of the second extension portion onto the base substrate are arranged in a direction intersecting the extension direction of the bus body proximate to the first conductive portion.

16. The display substrate according to claim 2, further comprising:
a gate driving circuit and a plurality of scanning lines, at least a part of an orthogonal projection of the bus body onto the base substrate being located between an orthogonal projection of the gate driving circuit onto the base substrate and orthogonal projections of the plurality of scanning lines onto the base substrate; and
a plurality of second conductive connection members, an orthogonal projection of each of the second conductive connection members onto the base substrate partially overlapping with an orthogonal projection of the bus body onto the base substrate, the plurality of second conductive connection members being coupled to the gate driving circuit, and the second conductive connection member and a corresponding scanning line forming an integral piece.

17. The display substrate according to claim 1, further comprising a plurality of normal subpixels, wherein each of the normal subpixels comprises a normal common electrode pattern;
a plurality of normal common electrode patterns comprised in the plurality of normal subpixels is grouped into the plurality of touch electrode blocks, each of the touch electrode blocks comprises at least two normal common electrode patterns, and in a same touch electrode block, the normal common electrode patterns arranged in a second direction are coupled to each other through a normal common electrode line; and
the dummy subpixel further comprises a dummy common electrode line, and a gap is provided between the dummy common electrode line and the normal common electrode line proximate to the dummy common electrode line in the second direction.

18. The display substrate according to claim 17, further comprising a plurality of data lines, wherein an orthogonal projection of each of the data lines onto the base substrate partially overlaps with an orthogonal projection of the normal common electrode line onto the base substrate.

19. The display substrate according to claim 17, wherein the dummy subpixel further comprises a dummy common electrode line, an end of the dummy common electrode pattern coupled to the dummy common electrode line comprises a first notch, and the first notch is arranged proximate to the normal common electrode line,
wherein the end of the dummy common electrode pattern coupled to the dummy common electrode line further comprises a second notch, and the second notch is arranged opposite to the first notch in the second direction.

20. (canceled)

21. A display device, comprising a display substrate, wherein the display substrate comprises a base substrate, and a plurality of touch electrode blocks, a plurality of dummy subpixels and a common signal bus arranged on the base substrate,
wherein an orthogonal projection of the dummy subpixel onto the base substrate is located between an orthogonal projection of the common signal bus onto the base substrate and an orthogonal projection of the touch electrode block onto the base substrate, the dummy subpixel comprises a dummy common electrode pattern, and the dummy common electrode pattern is coupled to the common signal bus.
